(19) United States
(12) Patent Application Publication
(10) Pub. No.: US 2026/0275066 A1
(43) Pub. Date: Sep. 17, 2026

(54) METHOD FOR PREPARING FOAM MOLDED PARTS WITH COATED PARTICLES

(71) Applicant: BASF SE, Ludwigshafen am Rhein (DE)

(72) Inventors: Anna Maria CRISTADORO, Lemfoerde (DE); Elmar POESELT, Lemfoerde (DE); Christian-Andreas WINKLER, Ludwigshafen am Rhein (DE); Florian Tobias RAPP, Ludwigshafen am Rhein (DE); Cornelia CHELLA, Ludwigshafen am Rhein (DE)

(73) Assignee: BASF SE, Ludwigshafen am Rhein (DE)

(21) Appl. No.: 19/168,891

(22) PCT Filed: Mar. 27, 2024
(86) PCT No.: PCT/EP2024/058199

§ 371 Date: Sep. 25, 2025

(30) Foreign Application Priority Data
Mar. 31, 2023 (EP) 23166046.5

(51) Int. Cl. C08J 9/224; C08J 9/236

(52) U.S. Cl. CPC C08J 9/224; C08J 9/236; C08J 2323/00; C08J 2323/12; C08J 2325/06; C08J 2375/08; C08J 2377/00

(57) ABSTRACT

The present invention relates to a method for the preparation of a particle foam molded part comprising fusing coated foam particles by supplying energy at least partially through an electromagnetic field with a frequency in the range from 1 MHz to 100 MHz, wherein the coated foam particles comprise a polymeric coating selected from the group consisting of acrylic polymers, styrene-acrylic polymers, vinylester polymers, ethylene vinylester polymers, styrene butadiene polymers, polyester polymers, polyamide polymers, polyolefin polymers, polyurethane polymers, polyurethane-polyacrylate hybrid polymers and polyurethane-polystyrene-butadiene hybrid polymers. The invention is further directed to the molded part obtained in the process as well as the use thereof in shoe soles, part of shoe soles, shoe intermediate soles shoe insoles, damping elements, cushioning elements, underlays, grips, flooring, mattresses, sporting goods, bicycle saddles, tires and in automotive interiors and exteriors.

### BACKGROUND OF THE INVENTION

The present invention relates to a method for the preparation of a particle foam molded part comprising fusing foam particles, preferentially thermoplastic foam particles by supplying energy at least partially through an electromagnetic field, wherein the foam particles comprise a polymeric surface modification, which will be named “coating” in the following. The invention is further directed to the molded part obtained in the process as well as the use thereof in shoe soles, part of shoe soles, shoe intermediate soles, damping elements, cushioning elements, underlays, grips, flooring, mattresses, sporting goods, bicycle saddles, tires and in automotive interiors and exteriors.

The preparation of expanded thermoplastic elastomer bead foam is described within WO2014/198779 A1 using the extrusion technology while the preparation of parts out of the expanded thermoplastic elastomer beads is not explained.

WO2017/030835 A1 discloses a method of making a thermoplastic elastomer foam by incorporating a gaseous or supercritical blowing agent under pressure into a molten thermoplastic elastomer comprising polymeric crystalline domains, then releasing the pressure to foam the thermoplastic elastomer.

WO2015/052265 also describes the preparation of thermoplastic elastomer foam particles out of thermoplastic elastic polymers using an autoclave to impregnate the compact particles also referred to as granules. Afterwards the impregnated granules can be foamed and in a special case directly molded to a particle foam molding reducing the pressure within the autoclave. In another possibility, the impregnated granules are taken out and heated to the foaming temperature in a separate machinery.

Foam particles also referred to as bead foams, such as polypropylene or polystyrene bead foams, typically are fused together with superheated water vapor in automatic molding machines to form shaped foam molded parts for the packaging industry for example. The manufacturing of molded parts with foam particles of thermoplastic polyurethane by means of steam chest molding is described for example in DE102013110242 A1. Here, different variations on filling the mold are explained all with the intention to have a fully filled cavity.

Since superheated steam fusion has very high energy requirements, in recent years, there has been increasing search for alternatives. One alternative possibility to fuse the foam particles is to supply the required energy through an electromagnetic field. Using electromagnetic radiation or an electromagnetic field to provide the energy required for the molding process is described in general in EP3698949 A1 and WO2017/125410 A1 for different foam particles. Especially in WO2017/125410 A1 it is shown that a foam molded part with homogeneously fused foam particles can be achieved by using an electromagnetic field to apply the energy.

However, fusing foam particles through an electromagnetic field requires a certain excitability of the particle foams regarding electromagnetic radiation which results from their specific dielectric properties. A low material specific excitability regarding electromagnetic radiation will lead to high cycle times and, therefore, result in inefficient molding processes. Another task is to control the molding process in such a way that, on the one hand, the surfaces of the foam particles weld together sufficiently but at the same time the foam structure of the particles does not collapse leading for example to an unfavorable density increase.

WO2017/125410 A1 relates to a method for producing a particle foam molded parts wherein foam particles are heated in a mold such that they fuse together. This foam particles are made from polyurethane (PU), polylactate (PLA), polyethylene block amide (PEBA) or from polyethylene terephthalate (PET) which are inherent excitable by electromagnetic radiation. The heat is guided by means of electromagnetic radio frequency radiation to the foam particles. In case of large or thick particle foam molded parts it is described that they heat up more strongly in the middle than in the edge region. An increase of energy input by the electromagnetic field leads to a complete melting of the foam particles in the central area of the particle foam molded part.

In contrast to processing with steam, which is characterized by the fact that the steam acts only on the surface, the electromagnetic field causes heating of the entire foam particle. Depending on the component thickness, a longer cooling time may therefore be required before demoulding, which in turn affects the overall cycle time. Furthermore, the foam has an insulating effect and therefore, tends to retain heat inside the particles, which in turn might cause a damage of the cellular foam structure.

WO 2022/117331 A1 relates to a process for the production of functionalized particle foam mouldings based on thermoplastic base material with a glass transition temperature of at least 100° C. comprising the functionalization of particles. The used functionalization agents can be e.g., adhesives and electrically conductive base particles.

The modification of the surface of the foam particles is also described in EP3569647 A1, WO2022/223438 A1 and JP2001181437.

WO 2001/64414 discloses a method for bonding particles such as for example expandable polystyrene (EPS), expanded polypropylene (EPP) or expandable polyethylene terephthalate (EPET) thermally into molded parts by means of high-frequency fusion. In high-frequency fusion, the foam particles which are to be fused together are surrounded with a liquid medium absorbing electromagnetic radiation such as for example water, and then joined together by applying a form of electromagnetic radiation. Because of the water imbibition at the molding conditions due to the higher polarity of thermoplastic polymers, this method is not very suitable for foam particles comprising thermoplastic elastomers. The water imbibition allows the water to penetrate excessively into the foam particles, and, consequently, the heating takes place not just at points of contact but also within the particles. As a result, the foam structure within the particle may collapse prior to being fused.

WO 2016/146537 relates to a method for producing bead foam parts from foam beads based on thermoplastic elastomers, comprises foam beads being wetted with a polar liquid and joined together thermally in a mold via high-frequency electromagnetic radiation, especially microwave radiation, and the bead foams obtainable therefrom. As preferred polar liquids being used for wetting the foam beads esters of carboxylic acids and diols or triols are mentioned.

WO 2019/162172 A1 discloses a method for joining bodies by a thermoplastic elastomer preparation, characterized in that the preparation is heated by means of electromagnetic radiation and may contain an additive which absorbs the electromagnetic radiation.

DE102013012515A1 describes a process for joining foam particles, in particular EPP or EPS, together thermally by inductive heating achieving an improved energy balance compared to conventional methods such as for example molding by means of hot steam. To allow for the production of shaped moldings by inductive heating presupposes some electrical conductivity on the particle surfaces to be joined together. This is attainable by coating with electrically conductive fillers such as, for example, metallic powder or carbon black, nanotubes. Spraying is mentioned as possible way to coat the particle.

However, a homogeneous distribution of such electrically conductive additives on the surface is difficult. An inhomogeneous distribution of conductive additives on the surface can cause irregular heating and pose the risk of heat peaks. In addition, additives can accumulate in the tool and thus increase the maintenance effort. Additives incorporated into the material can help to optimize the response to electromagnetic radiation and increase energy efficiency, but it remains difficult to maintain the foam structure.

It was therefore an object of the present invention to remedy the disadvantages mentioned and to provide a method for the energy-efficient preparation of a homogeneous particle foam molding. Furthermore, it was an object of the present invention to provide a molding method which allows for a homogeneous heating of the particle surfaces and, in parallel, avoids the collapse of the inner foam structure of the used foam particles during the molding. A further object of the invention was the reduction of the total cycle time, by e.g. reduction of cooling times, required for the demolding, and thus achieve an additional reduction of the total cycle times by providing a method characterized in that only the surface of the foam particles is heated. Furthermore, it was an object of the present invention to provide a thermally reversible method of producing a particle foam molded part that allows the foam particles to be recovered and to be reused.

The problem is solved by a method for the preparation of a particle foam molded part comprising fusing polymeric foam particles by supplying energy at least partially through an electromagnetic field, wherein the foam particles comprise a polymeric coating.

### DETAILED DESCRIPTION OF THE INVENTION

With regards to the invention, the following can be stated specifically:

According to the present invention, the object is solved by a method for the preparation of a particle foam molded part comprising fusing coated foam particles by supplying energy at least partially through an electromagnetic field with a frequency in the range from 1 MHz to 100 MHz, wherein the coated foam particles comprise a polymeric coating selected from the group consisting of acrylic polymers, styrene-acrylic polymers, vinylester polymers, ethylene vinylester polymers, styrene butadiene polymers, polyester polymers, polyamide polymers, polyolefine polymers, polyurethane polymers, polyurethane-polyacrylate hybrid polymers and polyurethane-polystyrene-butadiene hybrid polymers.

Surprisingly, it was found that the method according to the present invention is associated with lower energy consumption compared to the methods of the state of the art. The use of coated foam particles with a polymeric coating selected from the group consisting of acrylic polymers, styrene-acrylic polymers, vinylester polymers, ethylene vinylester polymers, styrene butadiene polymers, polyester polymers, polyamide polymers, polyolefine polymers, polyurethane polymers, polyurethane-polyacrylate hybrid polymers and polyurethane-polystyrene-butadiene hybrid polymers for the preparation of a molded part through an electromagnetic field with a frequency in the range from 1 MHz to 100 MHz allows for a reduction of the voltage compared to the use of uncoated polymeric foam particles. Due to the fact, that the foam particles are exposed to lower energy, the foam structure of the particles is preserved. Thus, the risk of obtaining particle foam molded parts with increased density and stiffness due to a damaged foam structure can be significantly reduced.

Furthermore, the polymeric foam particles which comprise a polymeric coating show an improved response when exposed to an electromagnetic field and, thus, allow for obtaining parts with very short electromagnetic-field exposure time. As a result, the particle foam molded part is exposed to lower temperatures overall, which leads to a reduction in the required stabilization time (in case of passive cooling) or cooling effort in the case of active tool cooling. This generally translates in shorter cycle time.

With respect to a standard steam-based processes preparation of particle-foam molded parts through an electromagnetic field with a frequency in the range from 1 MHz to 100 MHz has generally the advantage of a reduced carbon footprint as generally less energy is consumed. The carbon footprint can be further reduced if polymeric-surface coated foam particles are used.

Moreover, in contrast to steam-based processes the molded parts are not wet after demolding and, therefore time-consuming annealing to remove the moisture is eliminated.

Furthermore, the particle-foam molded parts obtained according to the invention can be disassembled into individual foam particles again, as fusion is thermally reversible.

Foam particles or also foam beads or foam granules in the sense of the present invention refers to a foam in the form of a lot of loose particles of the same chemical nature, the average length of the particles preferably being in the range of 1 to 20 mm, determined according to DS/ISO 13322-2:2021. In the case of non-spherical, e.g., oval particles average length means the longest dimension by length. (determined by 3D evaluation of the granules, for example by means of dynamic image analysis with an optical measuring device named “PartAn 3D”, Microtrac).

The single foam granules according to the present invention preferably have an average mass in the range of 0.1 to 50 mg, preferable in the range between 0.5 and 45 mg. The average mass means in this context the arithmetic mean based on a sample size of 10 different particles wherein each particle is weighted three times.

The foam particles according to the invention usually have a bulk density of 20 g/l to 350 g/l, preferably 30 g/l to 250 g/l, more preferably 40 g/l to 200 g/l. The bulk density is measured analogously to DIN ISO 60:1999, wherein the determination of the above values in contrast to the standard, a vessel with 10 l volume is used instead of a vessel with 0.1 l volume, since especially for the foam particles with low density and large mass a measurement with only 0.1 l volume is too inaccurate.

In general, all kind of foam particles can be used, such as for example shredded foam parts or polymeric foam waste material based on thermosetting, thermoplastic, or elastomeric polymers.

In a preferred embodiment the foam particles are selected from the group consisting of styrene polymer foam particles, polyurethanes foam particles, polyamide foam particles, thermoplastic elastomer foam particles, polyolefine foam particles and mixtures thereof.

Useful thermoplastic elastomers for foam particles include, for example, thermoplastic polyurethanes (TPU), thermoplastic polyester elastomers (e.g., polyether esters and polyester esters), thermoplastic copolyamides (e.g., polyether copolyamides) or thermoplastic styrene-butadiene block copolymers.

In a preferred embodiment the foam particles are thermoplastic polyurethane foam particles.

Thermoplastic polyurethane foam particles according to the present invention are expanded foam particles and belong to the group of particle foams, which are also referred to as foamed pellets (or bead foams, particle foam, expanded thermoplastic elastomer particles or expanded thermoplastic polyurethane beads). Particle foams and moldings (also referred to as molded article) made therefrom, based on thermoplastic polyurethanes or other thermoplastic elastomers, are known (for example WO 94/20568A1, WO 2007/082838 A1, WO2017/030835 A1, WO 2013/153190 A1, WO 2010/010010 A1) and can be used in many ways.

It is also possible in accordance with the invention to use mixtures of different foam particles. In a preferred embodiment the foam particles comprise at least two foam particles based on different polymers or different particle size.

Two or more foam particles in the sense of the present invention refers to a mixture of different lots of loose foam particles, wherein the lots differ in their chemical nature.

In principle, all types of foam particles can be mixed regardless of their thermal properties such as melting point or glass transition.

In a preferred embodiment different thermoplastic foam particles are mixed. More preferably the foam particles comprise at least two thermoplastic foam particles selected from the group consisting of styrene polymer foam particles, polyamide foam particles, thermoplastic elastomer foam particles, polyolefin foam particles and mixtures thereof.

The foam particles according to the present invention can optionally be optimized by additives such as for example dyes, process aids, nucleating agents or stabilizers. The additives may be added during the generation of the precursor of the foam particles or during the foaming step. A precursor is a polymer composition that is used as input material for foaming.

A polymeric coating in the sense of the present invention refers to a coating with a polymeric composition, also referred to as coating material, which is bound to the particle surface as a distributed powder, patches, or a continuous shell-like layer, wherein the surface of the foam particles may be completely or partially covered with the polymeric composition.

In a preferred embodiment the polymeric coating is thermoplastic and has a softening temperature above 30° C. Softening temperature in the sense of the present invention means in case of amorphous thermoplastic coatings the glass transition temperature determined by differential scanning calorimetry according to DIN EN ISO 11357-2 (2014), as so-called midpoint temperature. The glass transition temperature of the polymeric coating is the glass transition temperature obtained when evaluating the second heating curve (heating rate 20 K/min) after heating the polymeric coating material to 130° C. (holding time 1 min) and cooling it with 20 K/min to −80° C. If the polymeric coating has more than one glass transition at least one glass transition temperature is in the range from 30 to 130° C. If the polymeric coating is semicrystalline the softening temperature in the sense of the present invention means the melting temperature determined according to DIN EN ISO 11357-3 (2018)(melting temperature=peak temperature) by heating with 20 K/min after cooling to −80° C.

In a more preferred embodiment the polymeric coating is thermoplastic and has a softening temperature in the range from 30° C. to 130° C.

Different methods are available to achieve the coating of the foam particles, wherein the polymeric composition which forms the coating can be applied to the particle surface in form of a melt, a powder, a polymeric solution or a liquid polymer dispersion.

In general, common methods for coating, like spray coating, e.g., as described in EP0009727A1 can be used. In a preferred embodiment, the particles are spray coated keeping them in motion via blowing them with e.g., air or mixtures of different gases.

In case of the powder coating, the foam particles are brought into contact with the powdered polymer composition in the solid state. Powder coating is a well-known method and a person skilled in the art is able to conduct said powder coating.

In a preferred embodiment the coating of the particle foams is achieved by bringing the foam particles into contact with the polymeric coating material in its molten state. To obtain a sufficient surface coating, preferably, the foam particles are kept in motion while applying the molten coating material by devices known to the person skilled in the art, such as for example kitchen mixer, cement mixer, conveyor belt, vibrating channel, or spray coating drum.

In a preferred embodiment the coating of the particle foams is achieved by, in a first step, bringing the foam particles into contact with a polymeric solution, wherein the coating material is dissolved in an organic solvent. In a second step, the organic solvent is removed by drying the foam particles at a temperature below the melting point of the coating material to obtain the coated foam particles. The first step can be carried out by methods known to the person skilled in the art, such as mixing the foam particles with the polymeric solution by drum mixers or rotor-stator mixers. For the drying step in principle, all suitable methods are possible, like convective drying, contact drying, infrared drying and, also microwave technology.

Suitable solvents are organic solvents, like acetone, acetonitrile, butanol, t-butyl alcohol, butanone (MEK), chlorobenzene, chloroform, cyclohexane, diethylene glycol, diethyl ether, dimethoxy ethane, dimethylformamide, dioxane, ethanol, ethyl acetate, ethylene glycol, glycerin, heptane, hexane, methanol, methyl t-butyl ether, N-methyl-2-pyrrolidinone, methylene chloride, pentane, propanol, pyridine, tetrahydrofuran, toluene, triethyl amine, xylene. A preferred organic solvent is MEK.

In a preferred embodiment the composition of the polymeric coating may also comprise functional additives and fillers in suitable amounts. Preferably the content of polymer of the polymeric coating is in the range between 60% and 100% related to the total mass of the polymeric coating.

Suitable fillers for polymeric coatings are in principle known to the person skilled in the art.

Functional additives are preferably selected from the group consisting of heat conductive additives, electrically conductive additives, antistatic aids, flame retardants, dyes, UV stabilizers, plasticizers, viscosity modifiers, hydrophobic agents, and mixtures thereof.

Hydrophobic agents or additives, such as waxes, silanes, polysiloxanes, silicone resins, can avoid uncontrolled water uptake of the foam particles, and therefore serve for an improved process control at electromagnetic-induced fusing processes.

Stabilizers are additives which protect a plastic material or in particular the foam particle from damaging environmental effects. Examples are primary and secondary antioxidants, sterically hindered phenols, hindered amine light stabilizers, UV absorbers, hydrolysis stabilizers, quenchers, and flame retardants.

Heat conductive and electrically conductive additives can be additionally used to increase the response of the coated foam particle to electromagnetic irradiation. Preferably heat and electrically conductive additives are selected from the group consisting of metal nitride, metal oxide, metal carbide, metal sulfide, metal silicate, silicon carbide, silicon nitride, boron nitride, carbon fibers, glassy carbon, carbon nanotubes, carbon nanobuds, aero graphite, linear acetylenic carbon, q-carbon, graphene, a salt, a monocrystalline powder, a polycrystalline powder, an amorphous powder, a glass fiber, and mixtures thereof.

The coating of the foam particles may comprise an amorphous or a semi-crystalline polymer.

In a preferred embodiment of the present invention the polymeric coating has a glass transition temperature lower than the melting temperature of the foam particles.

The glass transition temperature of the polymeric coating can be determined by differential scanning calorimetry according to DIN EN ISO 11357-2 (2014), as so-called midpoint temperature. The glass transition temperature of the polymeric coating is the glass transition temperature obtained when evaluating the second heating curve (heating rate 20 K/min) after heating the polymeric coating material to 130° C. (holding time 1 min) and cooling it with 20 K/min to −80° C.

If the coating is formed from a liquid dispersion, a drying step and preconditioning is required before the glass transition can be measured. The drying step is conducted by filling the dispersions into a heat able mold and keeping the dispersions there for 3 days at a temperature of 40° C. (within the mold-cavity). Usually, the dispersions form a film. For preconditioning the dried dispersion film are stored at 23° C. for 7 days.

The melting temperature of the foam particles is determined according to DIN EN ISO 11357-3 (2018)(melting temperature=peak temperature) by heating with 20 K/min after cooling to −80° C. In case of the foam particles the first heating run is evaluated.

In a preferred embodiment of the present invention the polymeric coating has a melting temperature Tₘ₁ lower than the melting temperature of the foam particles.

Melting temperature and enthalpy of fusion of the polymeric coating are determined according to DIN EN ISO 11357-3 (2018)(melting temperature=peak temperature) by heating with 20 K/min after cooling to −80° C., while enthalpy of fusion of the second run (Delta H2) is calculated from the area of second melting only.

If the coating is formed from a liquid dispersion, a drying step and preconditioning is required before measuring the melting temperature. The drying step is conducted by filling the dispersions into a heat able mold and keeping the dispersions there for 3 days at a temperature of 40° C. (within the mold-cavity). Usually, the dispersions form a film. For preconditioning the dried dispersion film are stored at 23° C. for 7 days. From the first heating run (heating rate 20 K/min) after cooling to −80° C., Tm1 and Delta H1 are determined. Tm2 and Delta H2 are determined from a second heating run (heating rate 20 K/min) after heating the polyurethane films to 130° C., cooling with 20 K/min to −80° C.

Glass transition temperature and melting temperature of the polymeric coating means in the sense of the present invention that the polymer comprised in the polymeric coating has these values.

In principle all suitable polymers which respond to electromagnetic irradiation alone or in combination with functional additives can be used as polymer in the polymeric coating.

In a preferred embodiment of the present invention the polymeric coating is selected from the group consisting of acrylic polymers, styrene-acrylic polymers, vinylester polymers, ethylene vinylester polymers, styrene butadiene polymers, polyester polymers, polyamide polymers, polyolefin polymers, polyurethane polymers, polyurethane-polyacrylate hybrid polymers and polyurethane-polystyrene-butadiene hybrid polymers.

In a preferred embodiment the polymeric coating comprises a polyurethane with a K-value in the range from 5 to 100 determined according to DIN EN ISO 1628-1 2021.

The K-value is a relative viscosity number, which is determined in analogy to DIN EN ISO 1628-1 2021 at 25° C. It comprises the flow rate of a 1 weight-% strength solution of the polyurethane in DMF, relative to the flow rate of pure DMF, and characterizes the average molecular weight of the polyurethane.

In a preferred embodiment the polymeric coating has a mass fraction in the range from 0.5% to 40% based on the total mass of the coated foam particles.

In a preferred embodiment the foam particles are coated with a polymer dispersion.

Preferably the polymer dispersion comprises at least one polymer as polymeric binder dispersed in a liquid dispersion medium, such as water, and optionally additives. Preferred additives are selected from the group consisting of ionic surfactants, non-ionic surfactants, rheology modifiers (including thickeners), anti-blocking additives, other dispersions, cross-linkers, plasticizers, stabilizers against hydrolytic degradation, biocides, fillers, additives that are excitable by electromagnetic radiation and antifoam agents.

Additives that are excitable by electromagnetic radiation are for example polar liquids based on esters of carboxylic acids and diols or triols.

More preferably the polymeric coating is applied as aqueous polymer dispersion.

The term “aqueous” means that the liquid in which the polymer is dispersed or solved is a mixture of liquids with a water content of more than 50% by weight based on the total weight of the mixture of liquids or the polymer is dispersed or dissolved in water as such. Suitable mixtures are mixtures or water with alcohol or the like. Mixtures are preferably mixtures of water with water-miscible solvents, for example alcohols, such as methanol, ethanol, n-propanol, isopropanol, n-butanol, sec-butanol, tert-butanol, n-hexanol and cyclohexanol; glycols, such as ethylene glycol, propylene glycol and butylene glycol; the methyl or ethyl ethers of dihydric alcohols, diethylene glycol, triethylene glycol, polyethylene glycols having number-average molecular weights up to about 3000 g/mol, glycerol and dioxane, and ketones, such as acetone in particular. In one specific embodiment the aqueous dispersion or solution is substantially free from organic solvents. “Substantially free from organic solvents” is to be understood as meaning that the proportion of organic solvents is not more than 5% by weight, particularly preferably not more than 1% by weight, in particular not more than 0.1% by weight, based on the total weight of the solvent.

A method to prepare an aqueous polymer dispersion that can be applied to obtain coated foam particles are described in WO 2022/223438.

Polymers suitable for aqueous polymer dispersions can be all film forming polymer dispersions from the product classes well known in the art, i.e., acrylic dispersions, styrene-acrylic dispersions, vinylester dispersions, ethylene vinylester dispersions, styrene butadiene dispersions, which are all prepared by free radical emulsion polymerization. Suitable polymers are also the well-known polyurethane dispersions, prepared by polyaddition reaction of isocyanates and polyols and subsequent dispersion in water, as well as the polyurethane-polyacrylate hybrid dispersions and polyurethane-polystyrene-butadiene hybrid dispersions. In each of these product classes, a large variety of monomers can be used in order tailor e.g., the glass transition temperature (Tg), the colloidal stability and other properties. Preferred polymers for water-based aqueous polymeric dispersions are aqueous polystyrene acrylic dispersions, aqueous acrylic dispersions, aqueous butadiene/styrene dispersions or aqueous polyurethane dispersions. More preferably, the water-based aqueous polymeric dispersion is an aqueous acrylic dispersion or an aqueous polyurethane dispersion. Even more preferably, the water-based aqueous polymeric dispersion is an aqueous polyurethane dispersion.

The polyurethane dispersions may be prepared for example by one of the following processes: According to the “acetone process”, an ionic polyurethane is prepared from the synthesis components in a solvent which is miscible with water, and which boils below 100° C. under atmospheric pressure. Sufficient water is added to form a dispersion in which water represents the coherent phase. The “prepolymer mixing process” differs from the acetone process in that, rather than a fully reacted (potentially) ionic polyurethane, a prepolymer is first of all prepared that carries isocyanate groups. The components in this case are selected such that the as-defined ratio A: B is greater than 1.0 and up to 3, preferably from 1.05 to 1.5. The prepolymer is first dispersed in water and then optionally crosslinked by reaction of the isocyanate groups with amines which carry more than 2 isocyanate-reactive amino groups, or chain extended by reaction of the isocyanate groups with amines which carry 2 isocyanate-reactive amino groups. Chain extension also takes place when no amine is added. In that case, isocyanate groups are hydrolyzed to amino groups, which are consumed by reaction with remaining isocyanate groups in the prepolymers, with chain extension. Customarily, if a solvent has also been used during the preparation of the polyurethane, the major portion of the solvent is removed from the dispersion, by means of distillation under reduced pressure, for example, The dispersions preferably have a solvent content of less than 10 weight % and with particular preference are free from solvents. Solvents are understood to mean organic solvents.

Preferably, the polyurethane of the aqueous polyurethane dispersion and comprised in the at least partly coated particle and shaped body according to the present invention is prepared from
a) at least one organic diisocyanate, selected from diisocyanates of the formula X (NCO) 2, where X is a noncyclic aliphatic hydrocarbon radical having 4 to 15 carbon atoms, a cycloaliphatic hydrocarbon radical having 6 to 15 carbon atoms, an aromatic hydrocarbon radical having 6 to 15 carbon atoms, or an araliphatic hydrocarbon radical having 7 to 15 carbon atoms, wherein the amount of aromatic diisocyanates is less than 60 mol-%, based on the sum of all organic diisocyanates a),
b) at least one dihydroxy compound selected from the group consisting of polyesterdiols and polytetrahydrofuran,
c) at least one compound having at least one group reactive toward isocyanate groups, and additionally carrying at least one ionic group or one group which can be converted into an ionic group, wherein the compounds c) preferably contain a group selected from carboxylate groups and sulfonate groups,
d) optionally further compounds different from a) to c).

In general, the aqueous polyurethane dispersion can be prepared by methods known in the art. Exemplary methods are described in WO 2021/249749 A1.

Particle foam molded parts (also referred to as particle foam articles or particle foam parts) are obtained or obtainable by, basically, all suitable methods for fusing the coated particle foams such as compression molding with either directly or indirectly heated molds.

A preferred method for the preparation of a foam molded part includes the following steps
(A) Inserting the foam particles according to the invention in a corresponding mold,
(B) Fusing the foam particles according to the invention from step (A).

The fusion in step (B) preferably takes place in a closed mold, wherein the fusion can be induced by steam, hot air or energetic radiation (microwaves, radio waves or infrared waves).

The temperature at the fusion of the coated foam particles is at least 10K higher than the softening temperature Tsoft of the polymeric coating. Preferably the temperature at the fusion of the coated foam particles is in the range from Tsoft+30K to Tsoft+40K. The softening temperature is in case of a semi-crystalline polymeric coating the melting temperature Tm1 or in case of an amorphous polymeric coating a glass transition appearing above room temperature (25° C.) determined by differential scanning calorimetry according to DIN EN ISO 11357-2 (2014) in the first heating run. Temperature at the fusion is the mass temperature in the mold cavity measured for example by means of an optical temperature sensor.

The particle foam molded parts can be produced by means of molding machines. For this purpose, the coated foam particles are conveyed into the shaping tool manually or automated by using pressurized air. The shaping tool also referred to as mold or molding tool comprises two primary components, the injection mold-plate with the filling nozzles, and a counterpart-plate. To generate the particle-foam molded part, both mold-plates are pressed together so that a cavity in the shape of the molding part is formed. The filling of the mold-cavity can be conducted either by crack filling method or by the pressure filling method.

The crack-filling method comprises the following steps:
(i) injecting the expanded foam particles into the mold-cavity without a backpressure of the counterpart-plate,
(ii) fusing the particles while closing the plates of the mold mechanically,
(iii) cool down the molding part and
(iv) demold the produced part,
wherein in step (i) a gap between the injection mold-plate and the counterpart-plate is adjusted which is also referred to as crack-height. The mold-cavity is filled with a predetermined amount of the expanded beads in step (i). In step (ii) the volume of the mold-cavity is reduced compared to step (i), because the two parts of the molding tool are closed tightly and the intermediate gap is, thus, disappeared. This leads to a pressure increase within the mold-cavity. The expanded foam particles are thus pressed against one another and can therefore become fused to give the molding.

The pressure filling method comprises the following steps:
(i) injecting the foam particles into the mold-cavity by pneumatic pressure while compressing both plates of the mold tightly together,
(ii) fusing the particles,
(iii) cool down the particle-foam molded part,
(iv) demold the produced part

Since the exerted injection pressure in step (i) is ceased in step (ii) the inserted foam particles may further expand and as a result be pressed against one and another and, therefore, become fused and give the molding.

In a preferred embodiment according to the invention the energy for fusing the coated foam particles is supplied at least partially by electromagnetic induction. For this purpose, a dielectric molding-tool is placed in between at least two capacitor plates which generate at least one dielectric field. The foam particles are loaded into the cavity of the molding tool and are heated by applying the dielectric field. As a result, the coating of the foam particles is partially molten and, therefore the foam particles become fused and form the particle-foam molded part. To preserve the foam morphology and melt the coating only, the process is adapted in accordance with the used materials and the design of the molded part. In general, the energy input is controlled and adjusted by the applied voltage, the irradiation time, and the amount of material. Before the particle-foam molded part can be removed from the molding tool, it must be stabilized and cooled down. The stabilization can be achieved by stopping the active heating or by means of an active cooling-procedure, such as for example described in EP3405322.

Fusing by energetic radiation is generally carried out in the radio-frequency range of 1 MHz-100 MHz. Radio waves are preferably applied in the frequency range between 1 MHz and 80 MHz and irradiation times between 0.1 and 30 min are used.

In a preferred embodiment the method is comprising the steps of
(i) wetting the surface of the foam particles with an aqueous polymer dispersion,
(ii) obtaining coated foam particles by drying the wetted foam particles,
(iii) loading the coated foam particles into a mold,
(iv) fusing the coated foam particles by supplying energy at least partially through an electromagnetic field in the range from 1 MHz to 100 MHz.

In a preferred embodiment the particle foam molded part is obtainable or obtained by a method according to the invention.

In a preferred embodiment the particle foam molded part obtainable or obtained by a method according to the invention has a specific volume resistance measured according to DIN EN 62631-3-1:2017-01 of less than 1.0E+12 Ohm*cm.

In a preferred embodiment the particle foam molded part is produced with storage stable and tack-free particles. Tack-free in the sense of the present invention means that no agglomeration or clogging between the particles occurs when the coated foam particles are stored e.g., in octabins or silos for longer times at temperatures below 30° C. Storage stable in the sense of the present invention means that no cross-linkage or degradation of the polymeric coating occurs when the coated foam particles are stored e.g., in octabins or silos for longer times at temperatures below 30° C.

In a preferred embodiment additional material (inliners) can be fused together with the foam particles into a hybrid particle foam molded part. Preferably inliners are selected from the group consisting of synthetic or natural textiles, chopped textiles, leather, paper, thermoplastic films, thermoplastic tapes, organo-sheets, pieces of fiber composites, rubber sheets, rubber crumbs, pieces of wood, thermosetting films, plastic agglomerates, and mixtures thereof. The inliners can be fused together with the foam particles in one step or in a separate processing step.

A further aspect of the invention relates to the use of the particle foam molded part according to the invention in shoe soles, part of shoe soles, shoe intermediate soles shoe insoles, damping elements, cushioning elements, protective devices, underlays, grips, flooring, mattresses, sporting goods, bicycle saddles, tires and in automotive interiors and exteriors.

In a preferred embodiment the method is comprising the steps of
(v) wetting the surface of the foam particles with an aqueous polymer dispersion,
(vi) obtaining coated foam particles by drying the wetted foam particles,
(vii) loading the coated foam particles into a mold,
(viii) fusing the coated foam particles by supplying energy at least partially through an electromagnetic field in the range from 1 MHz to 100 MHz.

In a preferred embodiment the aqueous polymer dispersion of step (i) is selected from the group consisting of acrylic dispersions, styrene-acrylic dispersions, vinylester dispersions, ethylene vinylester dispersions, styrene butadiene dispersions, polyurethane dispersions, polyurethane-polyacrylate hybrid dispersions and polyurethane-polystyrene-butadiene hybrid dispersions.

In a preferred embodiment of the method the aqueous polymer dispersion of step (i) is a polyurethane dispersion, and the polyurethane has a K-value in the range from 5 to 100 determined according to DIN EN ISO 1628-1 2021.

In a preferred embodiment of the method the foam particles are selected from the group consisting of styrene polymer foam particles, polyurethane foam particles, polyamide foam particles, thermoplastic elastomer foam particles, polyolefine foam particles and mixtures thereof.

In a preferred embodiment of the method the foam particles are thermoplastic polyurethane foam particles.

In a preferred embodiment of the method the foam particles comprise at least two foam particles based on different polymers or different particle size.

In a preferred embodiment of the method the dried coating obtained in step (ii) has a mass fraction in the range from 0.5% to 40% based on the total mass of the coated foam particles.

In a preferred embodiment of the method the polymer of the aqueous polymer dispersion in step (i) is an amorphous polymer and, the glass transition temperature of the polymer of the aqueous polymer dispersion is smaller than the melting temperature of the foam particles.

In a preferred embodiment of the method the polymer of the aqueous polymer dispersion in step (i) is a semi-crystalline polymer and, the melting temperature of the polymer of the aqueous polymer dispersion is smaller than the melting temperature of the foam particles.

In a preferred embodiment of the method in step (iv) the frequency of the electromagnetic field is in the range from 1 MHz to 100 MHz.

In a preferred embodiment the particle foam molded part is obtainable or obtained by a method according to the invention.

In a preferred embodiment the particle foam molded part obtainable or obtained by a method according to the invention has a specific volume resistance measured according to DIN EN 62631-3-1:2017-01 of less than 1.0E+12 Ohm*cm.

A further aspect of the invention relates to the use of the particle foam molded part according to the invention in shoe soles, part of shoe soles, shoe intermediate soles shoe insoles, damping elements, cushioning elements, protective devices, underlays, grips, flooring, mattresses, sporting goods, bicycle saddles, tires and in automotive interiors and exteriors.

### BRIEF DESCRIPTION OF THE FIGURES

FIG. 1 scanning electron microscope (SEM) picture showing fused coated foam particle according to example 1

FIG. 2 scanning electron microscope (SEM) picture showing the coating between two fused coated foam particles after fusion of example 1

FIG. 3 picture of the surface of a foam molded part according to example 4 and example 6 (see table 5)

FIG. 4 picture of the surface of a foam molded part generated by heat-press according to comparative example 25

FIG. 5 heat-flow curve of a differential scanning calorimetry measurement of a dried polyurethane film obtained from dispersion 1 determined from the second heating run with a heating rate of 20 K/min with the temperature in ° C. on the x-axis and the heat-flow in W/g on the y-axis

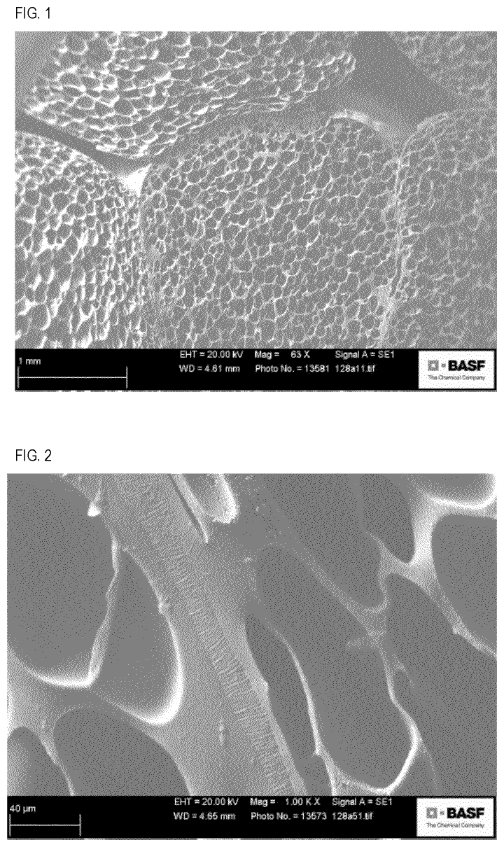

### EXAMPLES

### Preparation of Dispersions for Coating

### Dispersion 1

676 g of a polyesterdiol with an OH number of 45 (based on adipic acid and 1,4 butanediol) were reacted with 0,11 g titaniumtetrabutylate, 40 g isophorone diisocyanate (IPDI), 0.77 g NCO-terminated polycarbodiimid (Elastostab H02, BASF) at 60° C. in 153 g dry acetone for 60 min. Then, 37.8 g 1,6-hexane diisocyanate (HDI) was added and the temperature raised to 74° C. The reaction is continued until the NCO-value is lower than 1.25%. The mixture was diluted with 539 g acetone and cooled to 35-40° C. Then 22.4 g of aminoethyl aminoethansulfonate sodium salt (50% in water) diluted with 22 g demineralized water was added within a period of 3 min, followed by 4.6 g isophorone diamine diluted in 23 g demineralized water also added within a period of 3 min. Before dispergation, 38.7 g of a 20% aqueous solution of alkyl polyethylene glycol ether made from a linear, saturated C16C18 fatty alcohol with 18 moles of ethylene oxide, 20% active (e.g., Lutensol AT18 from BASF) was added. In the next step, the dispergation of the produced compound with 463 g demineralized water was carried out by using an anchor stirrer over a period of 15 min. Immediately after the water feed, additionally 4 g of N-(2-aminoethyl)-ethanolamine solved in 30 g water was added during the dispergation. During dispergation an additional amount of 200 g demineralized water was added Water.

After the dispergation step, the acetone was removed by vacuum distillation with the help of two drops of defoamer (FoamStar PB 2724, BASF) and the solids content of the obtained semicrystalline dispersion adjusted to 50 wt %. The properties of the obtained dispersion are shown in Table 1.

TABLE 1

| | Dispersion 1 | |
|---|---|---|
| Tm1 | 51° | C. |
| DELTA H1 | 54 | J/g |
| Tm2 | 46° | C. |
| DELTA H2 | 32 | J/g |
| K-value | 60 | |
| Viscosity | 169 | mPas |
| Tg | −55° | C. |

### Dispersion 2

1039 g of a polyesterdiol from Adipic acid and Isophthalic acid (molar ratio of 1:1) and 1,6 g Hexanediol (molecular weight 2000 g/mol), 104,6 g of Dimethylolpropionic acid (DMPA) 186.8 g Butanediol-1,4 were reacted with 900 g isophorone diisocyanate (IPDI) in 530 g dry acetone in a pressurized reactor; starting at 50° C., increasing the temperature in 30 min to 90° C., then as 90° C. is reached keeping the temperature constant for 8 h at 2.9 bar. After that, the obtained mixture was diluted with 1852 g acetone, cooled to 40° C. and expanded to atmospheric pressure. The NCO-value was determined to 1.2%. Then 10.2 g of Isophoronediamine were added in a shot, followed by adding 81 g Diethylethanolamine (neutralization agent) within a period of 5 min. After 5 min stirring, the dispersion step was continued by adding 3567 g deionized water within a period of 37 min at 30° C., followed by an addition of 19.8 Diethylenetriamine diluted in 340 g deionized water within a period of 30 min. After that, the acetone was removed by vacuum distillation with the help of 0.23 g of defoamer (FoamStar PB 2724, BASF), resulting in Dispersion 2 with a solids content of 37.4%.

The properties of the obtained dispersion 2 are shown in Table 2.

TABLE 2
Dispersion 2

| K-value | 63 | |
|---|---|---|
| Viscosity | 31 | mPas |
| Tg1 | −20° | C. |
| Tg2 | 69° | C. |

The thermal properties and the K-values shown in table 1 and table 2 were measured on a dried film of the respective dispersion. For this purpose, the dispersions were filled into a heat able mold and kept there for 3 days at a temperature of 40° C. (within the mold-cavity). Afterwards, the dried dispersion films were stored at 23° C. for 7 days before the thermal analysis was conducted.

The viscosities shown in table 1 and table 2 refer to the aqueous dispersions and were measured according to DIN EN ISO 3219-2:2021 at 23° C. and a shear rate of 250s-1.

### Preparation of Coated Polymeric Foam Particles

Dispersion 1 was mixed with thermoplastic polyurethane elastomer foam particles (e-TPU), made according WO2013/153190 A1 (example 1) with a Vollrath dissolver for 60 second at room temperature. Afterwards, the wetted foam particles were spread on Teflon foils and dried there at room temperature for about 10 minutes, keeping attention to isolate them from each other. Afterwards, the tack-free and storage stable coated foam particle were collected for further processing. The thermoplastic polyurethane of the used thermoplastic elastomer foam particles (e-TPU) is based on 4,4-methylendiphenyldiisocyanate, 1,4-butandiol and polyetherpolyol with an OH-number of 112,2.

Dispersion 2 was mixed with thermoplastic polyurethane elastomer foam particles (e-TPU), made according WO2013/153190 A1 (example 1) with a Vollrath dissolver for 60 second at room temperature. Afterwards, the wetted foam particles were spread on Teflon foils and dried there at room temperature for about 10 minutes, keeping attention to isolate them from each other. Afterward, the tack-free and storage stable coated foam particle were collected for further processing. An overview of the generated coated foam particles is given in Table 3.

Dispersion 1 was mixed with eTPA (1), made according to Example 9 of WO2017220671 (having a bulk density 64 g/l and a particle weight of 19 mg) with the help of a kitchen mixer, equipped with a dough hook. The beads were mixed until the water was evaporated. For 100 g of product around 15 minutes until drying of the particles. The process leads to coated beads, which are tack-free and storage stable.

Dispersion 1 was mixed with eTPA (2), made according to Example 12 of WO2017220671 (having a bulk density 40 g/l and a particle weight of 17 mg) with the help of a kitchen mixer, equipped with a dough hook. The beads were mixed until the water was evaporated. For 100 g of product around 15 minutes until drying of the particles. The process leads to coated beads, which are tack-free and storage stable.

Dispersion 2 was mixed with ePS, expanded polystyrol, obtained expanding Styropor® P 326 C to a bulk density 20 g/l with the help of a kitchen mixer, equipped with a dough hook. The beads were mixed until the water was evaporated. For 100 g of product around 15 minutes until drying of the particles. The process leads to coated beads, which are tack-free and storage stable.

Dispersion 2 was mixed with lose e-PA beads (produced by the procedure described in WO2021052881 A1) with the help of a kitchen mixer, equipped with a dough hook. The beads were mixed until the water was evaporated. For 100 g of product around 15 minutes until drying of the particles. The process leads to coated beads, which are tack-free and storage stable.

Dispersion 2 was mixed with lose e-PP beads (Neopor, BASF) with the help of a kitchen mixer, equipped with a dough hook. The beads were mixed until the water was evaporated. For 100 g of product around 15 minutes until drying of the particles. The process leads to coated beads, which are tack-free and storage stable.

Dispersion 2 was mixed with lose e-TPO (Argilix-O, JSP) with the help of a kitchen mixer, equipped with a dough hook. The beads were mixed until the water was evaporated. For 100 g of product around 15 minutes until drying of the particles. The process leads to coated beads, which are tack-free and storage stable.

An overview of the generated coated foam particles is given in Table 3. In it, mass fraction of the dispersion is based on the total mass of particles and the amount of dispersion used, e.g., 5 g of dispersion were mixed with 95 g of foam particles means a weight fraction of 5% dispersion.

TABLE 3

| | | | | mass fraction |
|---|---|---|---|---|
| | | | mass fraction | of dried |
| | particle | | of dispersion | coating layer |
| | foam | coating | [%] | [%] |
| sample 1 | e-TPU | Dispersion 1 | 5 | 2.5 |
| sample 2 | e-TPU | Dispersion 1 | 10 | 5 |
| sample 3 | e-TPU | Dispersion 1 | 15 | 7.5 |
| sample 4 | e-TPU | Dispersion 1 | 20 | 10 |
| sample 5 | e-TPU | Dispersion 2 | 15.6 | 5.8 |
| sample 6 | e-TPA (1) | Dispersion 1 | 10 | 5 |
| sample 7 | e-TPA (2) | Dispersion 1 | 10 | 5 |
| sample 8 | e-PS | Dispersion 2 | 13.5 | 5 |
| sample 9 | e-PA | Dispersion 2 | 13.5 | 5 |
| sample 10 | e-PP | Dispersion 2 | 13.5 | 5 |
| Sample 11 | e-TPO | Dispersion 2 | 13.5 | 5 |
| reference 1 | e-TPU | — | — | — |

### Determination of Electrical Resistance

The foam particles of reference 1 and the coated foam particles of sample 1 and sample 3 (see table 3) were heat pressed for obtaining a molded part in the shape of a plate according to the following procedure:

65 g of foam particles (sample 1, sample 3, reference 1) were placed in the cavity of a preheated molding tool with the cavity dimensions 16.3 cm×9.6 cm×3.3 cm (length, width, height), which was previously sprayed with a silicon-based release agent (e.g., Indrosil 2000). The filled mold cavity was covered with a mold lid (also sprayed with Indrosil 2000), which allows for a compression of 50% of the height of the mold cavity. After closing the mold with the lid, the particle foam was pressed for a period of 10 min and at a mold-temperature of 140° C. The residual time for cooling down the fused 3 D molded part prior to demolding was 5 minutes. The demolded sample-plates with a part density of 0.250 g/cm³ were characterized by the following dimensions: 16 cm×9.5 cm×1.6 cm.

Afterwards, the demolded sample-plates were cut into the dimensions of 12 cm×9.5 cm×1.6 cm in order to measure the specific volume resistance according to DIN EN 62631-3-1 (VDE 0307-3-1): 2017-01. Table 4 reports the electrical resistance of the sample-plates obtained with coated beads and of the reference sample-plate, obtained with non-coated E-TPU beads:

TABLE 4

| | | specific volume | |
|---|---|---|---|
| plate | samples | resistance | unit |
| 1 | reference 1 | 1.10E+12 | Ohm*cm |
| 2 | sample 1 | 3.00E+11 | Ohm*cm |
| 3 | sample 3 | 1.50E+11 | Ohm*cm |

As can be seen from the table, the specific volume resistance of molded plates realized by using coated foam particles is lower compared to the specific volume resistance of molded plates of non-coated foam particles. This translates in a better response of coated foam particles to electromagnetic irradiation. It can be assumed that the same trend can be observed in case of radio-frequency molding.

### Preparation of Particle Foam Molded Parts

The foam particles were molded into parts using a molding machine (Wave Foamer by company Kurtz Ersa) equipped with an electromagnetic field generator and a polyethylene-terephthalate-mold with a length and a width of 200 mm each and a variable height that can be set to 10 or 20 mm by changing the inlay of the mold.

For molding, the cavity was opened and all surfaces of the cavity of the molding tool were lined with polytetrafluoroethylene-foil. Then, the required amount of foam particles was placed manually into one half of the open mold and distributed evenly. In case of 10 mm cavity height, 98.8 g foam particles were filled into the mold, and, in case of 20 mm cavity height, 197.6 g foam particles were filled into the mold. Afterwards, the molding tool was closed, and the molding process conducted with the specific conditions as listed in Table 5. Generally, the foam particles were conditioned to ambient air for a minimum of 10 days after application of coating prior to molding and then exposed to the electromagnetic field for a certain exposure time as shown in Table 5. Thereby, the frequency of the electromagnetic field was adjusted at 27.14 MHz. In addition to the exposure time, the applied voltage of the electromagnetic field was varied (see Table 5). All settings shown in Table 5 have resulted from a feasibility study to define the accessible process window where the following criteria are met:
no loose beads after opening the mold and demolding of the plate,
optical judgement (no immediate post-blowing of the sample-plate after demolding, no melting of the foam particles in the central area, cellular structure has been preserved)
tearing apart the sample-plate manually immediately after demolding requires a lot of force (shows sufficient fusion)

TABLE 5

| | Plate | Exposure | | Particle |
|---|---|---|---|---|
| | thickness | Time | Voltage | foam |
| Example | [mm] | [s] | [kV] | sample |
| example 1 | 10 | 20 | 3.5 | sample 2 |
| example 2 | 10 | 20 | 4.0 | sample 2 |
| example 3 | 10 | 20 | 4.0 | sample 2 |
| example 4 | 10 | 20 | 4.5 | sample 2 |
| example 5 | 10 | 20 | 5.0 | sample 2 |
| example 6 | 10 | 24 | 5.5 | sample 2 |
| example 7 | 20 | 30 | 5.0 | sample 2 |
| example 8 | 20 | 40 | 5.5 | sample 2 |
| example 9 | 20 | 40 | 5.25 | sample 2 |
| comparative | 20 | 30 | 5.0 | reference 1 |
| example 10 | | | | |
| comparative | 20 | 40 | 5.25 | reference 1 |
| example 11 | | | | |
| comparative | 20 | 40 | 5.5 | reference 1 |
| example 12 | | | | |
| comparative | 10 | 20 | 3.5 | reference 1 |
| example 13 | | | | |
| comparative | 10 | 20 | 4.5 | reference 1 |
| example 14 | | | | |
| comparative | 10 | 24 | 5.5 | reference 1 |
| example 15 | | | | |
| example 16 | 10 | 20 | 3.0 | sample 5 |
| example 17 | 10 | 20 | 3.5 | sample 5 |
| example 18 | 10 | 20 | 4.0 | sample 5 |
| example 19 | 10 | 20 | 4.5 | sample 5 |
| example 20 | 20 | 30 | 3.0 | sample 5 |
| example 21 | 20 | 30 | 3.5 | sample 5 |
| example 22 | 20 | 30 | 4.0 | sample 5 |
| example 23 | 20 | 30 | 4.5 | sample 5 |
| comparative 24 | 10 | 20 | 3.0 | reference 1 |

Before demolding, a stabilization time within the closed mold was required to cool down the molded parts passively. The stabilization time strongly influences the cycle time and was therefore optimized towards the minimum required stabilization time for the specific grade of foam particles. For this purpose, molded parts of the same sample of foam particles at the same process conditions except the stabilization time were prepared. 3 minutes after demolding the thicknesses of the respective molded parts were measured at the thickest point of the molded parts by means of a digital caliper. An overview of the stabilization time on the thickness of the obtained molded part can be found in Table 6. Furthermore, the optical quality of the molded parts was evaluated by assessing the swelling after demolding. The optical quality was rated with grades 1, 2 and 3, wherein grade 1 means no swelling occurred after demolding and the part is dimensionally stable (e.g., no thickness increase could be observed). Grade 2 stands for slight swelling and dimensional changes of the thickness below 1 mm. In case of grade 3 the swelling is clearly observable, and the overall dimensional stability is poor. Table 6 compares the quality rating and the thickness of the molded part after demolding of inventive example 4 with comparative example 15 for different stabilization times. In case of 10 mm cavity height, the use of coated foam particles according to the invention allows for a significant reduction of the stabilization time, because the target thickness of approximately 10 mm is already reached after 200 s (example 4, Table 6). In contrast, in case of the uncoated foam particles a stabilization time of at least 450 s is required (see comparative example 15, Table 6). This corresponds to a cycle time reduction of almost 50%. Another series of tests on the influence of stabilization time adjusting 20 mm cavity height confirms the positive effect of the particle coating. The demoulded parts out of the coated foam particles according to example 7 achieve already after 450 s stabilization time dimensional stability and the target thickness while the demolded parts out of uncoated foam particles according to the corresponding comparative example 12 need a stabilization time of 900 s for the same result (see Table 6).

TABLE 6

| | | Cavity | Dosing | | | Thickness | |
|---|---|---|---|---|---|---|---|
| | Stabilization | height | amount | Exposure | Voltage | demolded | Quality |
| | time [s] | [mm] | [g] | time [s] | [kV] | part [mm] | rating |
| Example 4 | 80 | 10 | 98.8 | 20 | 4.5 | 11.6 | 3 |
| | 150 | 10 | 98.8 | 20 | 4.5 | 11.02 | 3 |
| | 200 | 10 | 98.8 | 20 | 4.5 | 10 | 1 |
| | 300 | 10 | 98.8 | 20 | 4.5 | 9.96 | 1 |
| | 600 | 10 | 98.8 | 20 | 4.5 | 9.85 | 1 |
| Comparative | 150 | 10 | 98.8 | 24 | 5.5 | 12.28 | 3 |
| example 15 | 300 | 10 | 98.8 | 24 | 5.5 | 10.71 | 2 |
| | 450 | 10 | 98.8 | 24 | 5.5 | 10.19 | 1 |
| | 600 | 10 | 98.8 | 24 | 5.5 | 9.93 | 1 |
| Example 7 | 300 | 20 | 197.6 | 30 | 5 | 22.5 | 3 |
| | 450 | 20 | 197.6 | 30 | 5 | 20.0 | 1 |
| | 675 | 20 | 197.6 | 30 | 5 | 20.05 | 1 |
| Comparative | 450 | 20 | 197.6 | 40 | 5.5 | 24.33 | 3 |
| example 12 | 675 | 20 | 197.6 | 40 | 5.5 | 21.5 | 2 |
| | 900 | 20 | 197.6 | 40 | 5.5 | 19.98 | 1 |

### Properties of Particle Foam Molded Parts

The particle foam molded parts produced with a cavity height of 10 mm were characterized with regard to tensile strength, elongation at break, rebound behaviour and the part density as shown in Table 7. The tensile strength and the elongation at break were measured according to ASTM D 5035:2011 using instead of fabric strips strips cut out of the respective foam molded part with a length of 150 mm and a width of 25.4 mm.

The rebound was measured according to DIN 53512:2000-4 using sample and the density of the obtained 3 D parts measured according to DIN EN ISO 845:2009-10.

In Table 7 example 1 corresponds in terms of voltage of the applied electromagnetic field during molding and in terms of cavity height with the comparative example 13; the same applies for example 4 and comparative example 14 as well as for example 6 and comparative example 15. As can be seen from Table 7, in all cases, the coating of the foam particles has led to significantly higher tensile strength and significantly higher elongation at break. Although, the densities of the molded parts are the same. Thus, it can be concluded that the coating significantly increases the mechanical properties. In addition, the comparative example 24 (table 5, table 7) shows that without coating at low voltages, radio-frequency molding doesn't lead to a sufficiently molded part.

TABLE 7

| | | Tensile | Elongation | |
|---|---|---|---|---|
| | Voltage | Strength | at break | Density |
| Example | [kV] | [MPa] | [%] | [g/cm³] |
| example 1 | 3.5 | 0.64 | 123 | 0.22 |
| example 17 | 3.5 | 0.57 | 68 | 0.212 |
| comparative | 3.5 | 0.16 | 30 | 0.23 |
| example 13 | | | | |
| example 4 | 4.5 | 0.81 | 171 | 0.238 |
| example 19 | 4.5 | 0.72 | 146 | 0.233 |
| comparative | 4.5 | 0.43 | 120 | 0.238 |
| example 14 | | | | |
| example 6 | 5.5 | 1.31 | 239 | 0.238 |
| comparative | 5.5 | 0.79 | 218 | 0.238 |
| example 15 | | | | |
| example 16 | 3.0 | 0.34 | 22 | 0.194 |
| comparative | 3.0 | no plate | no plate | no plate |
| example 24 | | | | |
| Example 18 | 4.0 | 0.59 | 129 | 0.212 |

### Comparative Example 25

Coated beads according to sample 3 (see table 4) were molded by means of heat press. For this purpose, 65 g of particle foams (sample 3) were placed in the cavity of a preheated molding tool with the cavity dimensions 16.3 cm×9.6 cm×3.3 cm (length, width, height), which was previously sprayed with a silicon-based release agent (e.g., Indrosil 2000). The filled mold cavity was covered with a mold lid (also sprayed with Indrosil 2000), which allows for a compression of 50% of the height of the mold cavity. After closing the mold with the lid, the particle foam was pressed for a period of 10 min and at a mold-temperature of 140° C. The residual time for cooling down the fused 3 D molded part prior to demolding was 5 minutes. The demolded sample-plates with a part density of 0.250 g/cm3 were characterized by the following dimensions: 16 cm×9.5 cm×1.6 cm (see FIG. 4).

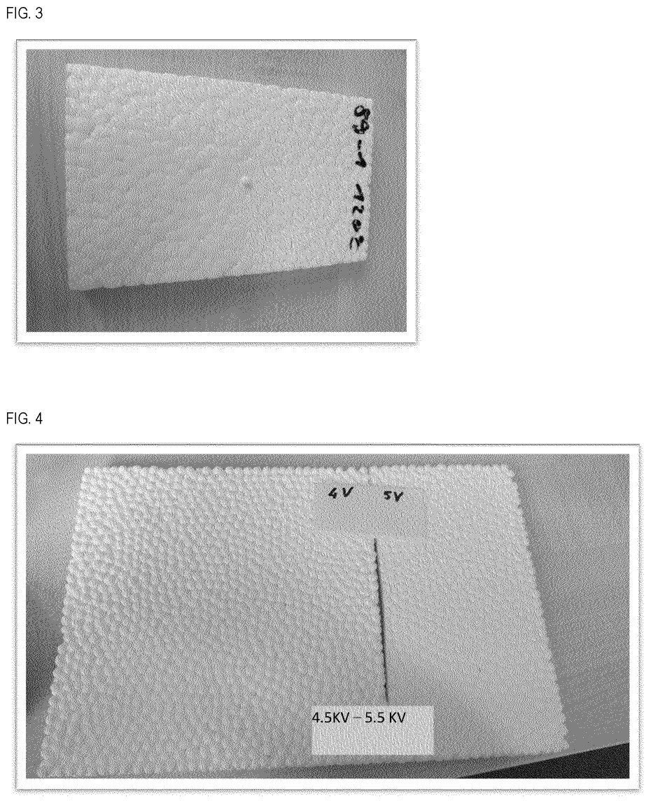

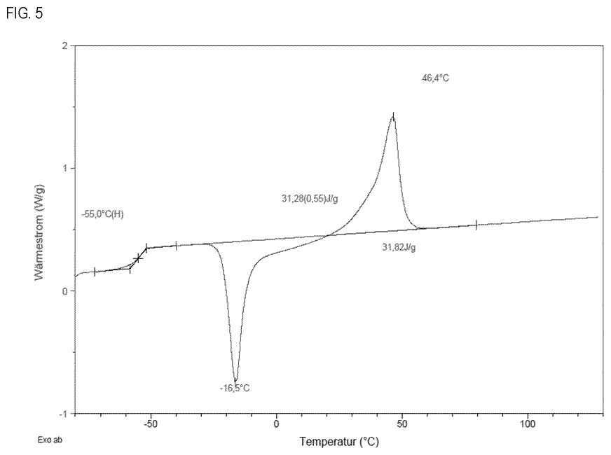

As can be seen from FIGS. 3 and 4, the different heat generation and heat distribution in the RF molding process leads to foam molded parts that differ significantly in their appearance from foam molded parts that have been generated with a heat-press or steam-chest molding process. While the individual foam particles are clearly visible in three dimensions in case of the RF-welded plate (see FIG. 3), the plate generated with a heat press has a significantly less surface-textured appearance (see FIG. 4) and a tendentially higher density.

### Debonding of Particle Foam Molded Part

The molded plate, made according to example 16, was placed in a 2L Becher glass, filled with 1000 mL Water and 5 g of liquid detergent (Persil Kraftgel). Afterwards, the plate was stirred for 30 minutes at a temperature of 90° C. with a magnetic stirrer. As a result, the loose foam particles could be recovered. Increasing the pH by adjusting the water solution to higher pH (pH=12) with NaOH accelerated the disassembly to 10 minutes.

1. A method for the preparation of a particle foam molded part, comprising fusing coated foam particles by supplying energy at least partially through an electromagnetic field with a frequency in the range from 1 MHz to 100 MHz, wherein the coated foam particles comprise a polymeric coating, and wherein the polymeric coating comprises a polyurethane with a K-value in the range from 5 to 100 determined according to DIN EN ISO 1628-1 2021.

2. The method according to claim 1, wherein the polymeric coating is thermoplastic and has a glass transition temperature measured according to DIN EN ISO 11357-2 (2014) or a melting temperature measured according to DIN EN ISO 11357-3 (2018) above 30° C.

3. The method according to claim 1, wherein the polymeric coating has a glass transition temperature measured according to DIN EN ISO 1137-2 (2014) lower than the melting temperature of the foam particles.

4. The method according to claim 1, wherein the polymeric coating has a melting temperature measured according to DIN EN ISO 1137-3 (2018) lower than the melting temperature of the foam particles.

5. (canceled)

6. The method according to claim 1, wherein the polymeric coating has a mass fraction in the range from 0.5% to 40% based on the total mass of the coated foam particles.

7. The method according to claim 1, wherein the foam particles are selected from the group consisting of styrene polymer foam particles, polyurethanes foam particles, polyamide foam particles, thermoplastic elastomer foam particles, polyolefine foam particles and mixtures thereof.

8. The method according to claim 1, wherein the foam particles are thermoplastic polyurethane foam particles.

9. The method according to claim 1, wherein the foam particles comprise at least two foam particles based on different polymers or different particle size.

10. The method according to claim 1, wherein the polymeric coating is applied as aqueous polymer dispersion.

11. The method according to claim 10 comprising:
(i) wetting the surface of the foam particles with an aqueous polymer dispersion,
(ii) obtaining coated foam particles by drying the wetted foam particles,
(iii) loading the coated foam particles into a mold,
(iv) fusing the coated foam particles by supplying energy at least partially through an electromagnetic field with a frequency in the range from 1 MHz to 100 MHz.

12. A particle foam molded part obtained by the method according to claim 1.

13. The particle foam molded part according to claim 12, wherein the specific volume resistance measured according to DIN EN 62631-3-1:2017-01 is less than 1.0E+12 Ohm*cm.

14. The particle foam molded part according to claim 12, which is a shoe sole, a part of a shoe sole, a shoe intermediate sole, a shoe insole, a damping element, a cushioning element, a protective device, an underlay, a grip, flooring, a mattress, a sporting good, a bicycle saddle, a tire, an automotive interior or an automotive exterior.
